(19) United States
(12) Patent Application Publication
(10) Pub. No.: US 2006/0100337 A1
(43) Pub. Date: May 11, 2006

(54) Method of producing polyamide nanocomposites and injection molded parts producible therefrom

(75) Inventors: Georg Stoppelmann, Bonaduz (CH); Martina Ebert, Domat/Ems (CH); Michael Kaisser, Trimmis (CH)

Correspondence Address: BROWDY AND NEIMARK, P.L.L.C.;624 NINTH STREET, NW, SUITE 300, WASHINGTON, DC, 20001-5303, US

(73) Assignee: EMS-CHEMIE AG, DORMAT/EMS (CH)

(21) Appl. No.: 10/526,766

(22) PCT Filed: Sep. 1, 2003
(86) PCT No.: PCT/EP03/09683

§ 371 Date: Nov. 3, 2005

(30) Foreign Application Priority Data
Sep. 6, 2002 (CH) 2002 1520/02

(51) Int. Cl. C08K 3/34

(52) U.S. Cl. 524/442

(57) ABSTRACT

A method of producing polyamide nanocomposites from partially crystalline polyamides and organically modified layered silicates in a double screw extruder is disclosed, a first part of the polyamides being dosed into the extruder intake and melted and the organically modified layered silicate being admixed with the melt of the polyamides and then a second part of the polyamides being added to the mixture. The method according to the present invention is distinguished in that the resulting melt is subjected to filtration. Injection molded parts and vehicle driving illuminator reflectors made of the polyamide nanocomposite molding compound produced according to the present invention are also disclosed.

The present invention relates to a method of producing polyamide nanocomposites according to independent Claim 1 and blanks, such as injection molded parts and/or light-reflecting components, producible therefrom.

Thermoplastics, from which light-reflecting components are produced through injection molding and subsequent metallization (vacuum deposition, typically using aluminum), are known. Such components are headlight reflectors for automobiles, for example. In addition to the paraboloid headlights which were previously used exclusively, two basic types have been developed which are optimized in regard to light usage and occupied space, the projection headlight (ellipsoid, polyellipsoid) and the free-form headlight. Since the cover disks of free-form headlights in particular may usually be designed without profiling because of the optimized light usage and distribution of this type of reflector, currently transparent disks made of polycarbonate or glass are used. This increases the requirements for the surface quality of elements which are easily visible from the outside (e.g., reflector, sub-reflector, frame), the dimensional stability in heat, the mechanical strength, simple processing, and low manufacturing tolerances also being important.

Such headlight reflectors may also be subdivided into the actual reflector, which essentially has a paraboloid shape, and a sub-reflector, which deviates more or less from the paraboloid shape. The reflector is the actual component, which reflects light in a targeted way for the desired illumination, and which is normally positioned directly surrounding the incandescent bulb which produces the light. In addition to light, the bulb also produces heat, so that the reflector is subjected to an operating temperature of approximately 180-210° C., depending on its construction. For peak temperatures of more than 220° C. or if the optical requirements are not too high, experience has shown that only sheet metal is used as a reflector material.

The part of the light-reflecting component which is farther away from the light source is called the sub-reflector. Sub-reflectors often cover the region between the reflector and the bulb housing and/or the remaining vehicle body or even the transparent bulb covering. Sub-reflectors therefore do not have to have a paraboloid extension which is used to increase the light yield, rather, they may fulfill an aesthetic object in that they represent a reflecting surface which appears to enlarge the reflector. Because of the greater distance from the light source, an operating temperature of at most approximately 150° C. is to be expected for sub-reflectors.

Metal coatings which are applied to the sub-reflectors to improve the reflection on the surfaces of the reflectors and to produce an aesthetic impression are not subjected to any direct mechanical stress, such as abrasion. Nonetheless, good adhesion of the metal coating on the reflector and sub-reflector surfaces is important, since blistering or even flaking may impair the light yield and worsen the aesthetic impression. In the following, the term “reflector” always also refers to sub-reflectors if no express differentiation is made between reflectors and sub-reflectors. The metallization of the reflectors is typically performed in vacuum by means of vapor deposition using PVD methods (PVD=physical vapor deposition, e.g., deposition or sputtering of aluminum, for example) and/or CVD methods (CVD=chemical vapor deposition, such as plasma-enhanced CVD). An important requirement for the plastic is therefore a low outgassing rate under the corresponding vacuum and temperature conditions. In order that the metal coatings of the reflectors are not damaged in operation, no increased outgassing may occur even at the high operating temperatures cited. In addition, the reflectors are to be dimensionally stable in a temperature range from −50° C. to 220° C., i.e., the expansion and contraction behavior is to be as isotropic as possible, so that—at least for the reflectors—the light yield and/or light bundling is not impaired. The metal coatings preferably have expansion and contraction behavior which is essentially identical to that of the reflectors, so that the tensile and/or shearing load of the reflective coatings is as small as possible. In this way, the danger of cracking or buckling in the reflective coatings is also reduced.

A further requirement relates to the surface qualities of the (usually curved) plastic surface to be coated. Especially for reflectors in which the light yield is essential, a smooth, high-gloss surface which is as homogeneous as possible must be provided for the coating. Plastics which flow poorly or solidify too early and/or an addition of fillers often leads to a rough, matte, or irregular impression in the injection mold, measured by the extremely high requirements of a mirror-smooth surface, even if the corresponding surface of the molding tool is polished to a high gloss.

Until now, duroplastics, and also, more rarely, thermoplastics, were used to produce reflectors. Of the latter, the amorphous thermoplastics primarily used, e.g., polyether imide (PEI) or polyether sulfones (PES and/or PSU or PPSU) have a high glass transition temperature (Tg). These amorphous high-Tg thermoplastics (HT thermoplastics) may be used without fillers to produce reflector blanks having outstanding surface gloss. The reflector blanks may be metallized directly. However, the high price of these amorphous HT thermoplastics is disadvantageous for mass production. The highest temperatures occur in the illumination unit, of course. Therefore, until now either the reflectors were made of sheet metal or metallized injection molded parts were produced from duroplastic (BMC) or amorphous HT thermoplastics (PC-HT, PEI, PSU, PES). The high tolerance requirements, coupled with the surface quality of the injection molded parts necessary for metallization, were fulfilled until now only by unfilled amorphous HT thermoplastics or enameled duroplastics, so that the use of partially crystalline materials was generally excluded.

Through the introduction of clear glass lenses, which are overwhelmingly used on the European market in the newer vehicle models, the frames or sub-reflectors have acquired great significance, and they are typically completely metallized. In addition to the basic function of the frames as a component of the main headlight for tailoring to fender and/or engine hood geometries and illumination functions, stylistic features are increasingly coming to the foreground. Essential requirements of the frames are (similarly to the reflectors) easy processability, outstanding surface quality, easy metallization, resistance to environmental influences and moisture, temperature stability, and dimensional stability. In addition to these traditional functions, further functional units, such as reflectors for turn signals, are increasingly integrated into the frames and/or the sub-reflector. In order to fulfill this requirement profile, until now a wide palette, from technical plastics to polymer blends to HT thermoplastics, was used. Examples are polyamide, polycarbonate, polysulfone (but not polyolefins) as well as blends based on PC, but especially on PBT. HT thermoplastics are used to achieve special thermal requirements (iridescence temperature up to 212° C. for Ultrason E from BASF, Ludwigshafen, Germany), the use of which is limited for economic reasons, however. “Ultrason E” is a polyarylene ether sulfone from BASF. In the course of the continuing reduction of complexity, increasing integration of headlight components into highly developed illumination systems is occurring, which will have higher material requirements (J. Queisser, M. Geprägs, R. Blum and G. Ickes, Trends bei Automobilscheinwerfern [Trends in Automobile Headlights], Kunststoffe [Plastics] March 2002, Hanser Verlag, Munich).

The partially crystalline polyphenylene sulfide (PPS), which is cited in European Patent 0 332 122 for the production of headlight reflectors, for example, also has very high thermal dimensional stability. In this case, a production method is disclosed in which a reflector blank (adding at most 250% carbon black to achieve increased electrical conductivity) is injection molded in a first work step. In a second work step, the reflector blank is electrostatically enameled to compensate for irregularities and to achieve a glossy surface, and in a third work step, it is aluminized in vacuum. This method is generally considered too complicated and too expensive for the mass production of reflectors, due to this additional enameling step. In addition, it is considered disadvantageous that the addition of fillers reduces the flowability of an injection molding compound and roughens the surfaces of the blanks produced in this way.

Compositions are known from European Patent 0 696 304 which include (a) a first polyamide, produced from an aromatic carboxylic acid component (isophthalic acid and/or terephthalic acid) and an aliphatic diamine component (hexamethylene diamine and 2-methyl-1,5-pentamethylene diamine); (b) a second aliphatic (polyamide 66, polyamide 6, or polyamide 46) or partially aromatic polyamide, which differs from the first polyamide; and (c) a mineral filler (kaolin, talc, mica, or wollastonite). It is disclosed in European Patent 0 696 304 that corresponding compositions having a high filler component of kaolin or mica (at least 4⁰%) may reach an HDT/A value of more than 200° C., but a glossy surface is only observed in the cases in which the composition also includes 10% glass fibers. However, the addition of such glass fibers also impairs the flowability of the composition during injection molding of molded parts and leads to an uneven surface and to less isotropic and/or more anisotropic contraction behavior.

Compositions are known from Japanese Patent 11 279 289 and Japanese Patent 11 303 678, which include granular metallic fillers made of Al, Ni, Sn, Cu, Fe, Au, Ag, Pt, or alloys such as brass or stainless steel (but particularly preferably Al) and from which molded parts having a metal-colored surface may be produced. The metallic impression of the surface of a corresponding molded part is decisively determined by the grain size of the metal particles, whose useful average diameter is to be between 10 μm and 200 μm. If possible however, the use of such particulate metal additives is to be dispensed with for reasons of easier reclamation and/or recycling of the materials in the production of new components.

A material for producing streetlight reflectors is known under the name Minlon® (E.I. du Pont de Nemours & Co., Wilmington, USA). The product cited is nylon 66 (PA 66) which, in addition to a heat stabilizer, also includes 36-40% classic mineral materials. However, this material does not appear to be suitable for vehicle travel illuminators due to the surface quality.

Film applications are known from German Patent application DE 198 47 844, in which a crystallizable polymer is admixed with at most 1% nanoscale fillers as a nucleation agent to improve the crystallization and therefore to improve the film properties. Thus, molded parts having higher rigidity, hardness, abrasion resistance, and toughness and/or films having good transparency and high gloss were achieved.

Polyamide nanocomposites having good thermal dimensional stability are known from European Patent application EP 0 940 430. The use of this polyamide composition for housings or mechanical parts in electrical equipment or electronics (e.g., switches or plugs), external or internal parts on automobiles, and gear or bearing housings in mechanical engineering is disclosed.

In European Patent 0 598 836 B1, the formation of polymer nanocomposites using exfoliated layered material in a melt method is described. Thus, for example, modified montmorillonite is incorporated into nylon 6 using an extruder. Molded parts produced therefrom have improved properties and are suitable for various intended purposes.

A method according to the species for producing polyamide nanocomposites from polyamides and organically modified layered silicates in a double screw extruder is known from WO 03/064503 A1. According to this method, a first part of the polyamides is dosed into the extruder intake and melted and the organically modified layered silicate is admixed with the melt of the polyamides. A second part of the polyamide is then added to the mixture.

The object of the present intervention is to suggest an alternative method, using which injection-molded reflectors may be produced having an at least approximately equally good surface (which is suitable for direct coating using a metal coating, for example) and at least approximately equally good thermal dimensional stability as using the materials known from the related art.

This object is achieved by the features of independent claim 1. Preferred embodiments and further features result from the dependent claims.

The method according to the present invention for producing polyamide nanocomposites from partially crystalline polyamides and organically modified layered silicates in a double screw extruder, in which a first part of the polyamides is dosed into the extruder intake and melted and in which the organically modified layered silicate is admixed with the melt of the polyamides and then a second part of the polyamides is added to the mixture, is distinguished in that the resulting melt is subjected to filtration.

The material produced in this case is a polyamide molding compound having a partially crystalline polyamide and a mineral filler, the mineral filler preferably having an ultrafine grain with an average particle size of at most 100 nm. Because the exfoliated layered silicate may also have a length of 1000 nm in the lengthwise direction for a synthetic fluorine mica, for example, this statement of the size relates to at least one dimension. The concept of polyamide is understood to include homopolyamides, copolyamides, and mixtures of homopolyamides and/or copolyamides. Polyamide nanocomposites having aliphatic polyamides and phyllosilicates are especially preferred. In this case, the homopolyamides PA 6, PA 66, PA 46, as well as PA 11 and PA 12, are preferred. Alternatively, mixtures made of partially crystalline polyamides having a component of amorphous polyamide are also conceivable; a component of partially crystalline polyamide is, however, always present in all polyamide nanocomposites produced according to the present invention. A preferred example of this variant is a mixture of partially crystalline PA 66 and amorphous PA 6I/6T, which is available from EMS-Chemie AG (CH-7013 Domat/Ems) under the trade name GRIVORY® GV.

Preferably, organically modified phyllosilicates are used, especially preferably those of the three-layer type (2:1), the polyamide molding compound preferably including at most 10 weight-percent thereof.

The phyllosilicates (layered silicates) of the three-layer type (2:1) include mica (e.g., muscovite, paragonite, phologopite, biotite, lepidolite, margarite), smectites (montmorillonite, hectorite), and vermiculite. These are preferably used in organically modified form so that they may be dispersed in exfoliated form in the polyamide matrix and express their maximum effect as nanocomposites.

Blanks may be injection molded from the polyamide molding compound of the present invention which, in spite of the filler component, are distinguished by a smooth surface having high gloss in the region where the mold was polished to a high gloss. This is even more astounding because, in comparison to the amorphous, unfilled high-Tg thermoplastics, both the crystallization during the solidification of the molding compound and the filler reduce the flowability and molding precision of the molding compound. Such blanks are especially suitable for direct metallization (e.g., using PVD methods) and use as reflectors.

It is also to be noted that the polyamide molding compounds may also contain typical additives, such as stabilizers (of differing types), flame retardants, auxiliary processing materials, antistatic agents, and further additives, in addition to the filler according to the present invention. Thus, the polyamide molding compounds of the following examples each also contained a heat stabilizer.

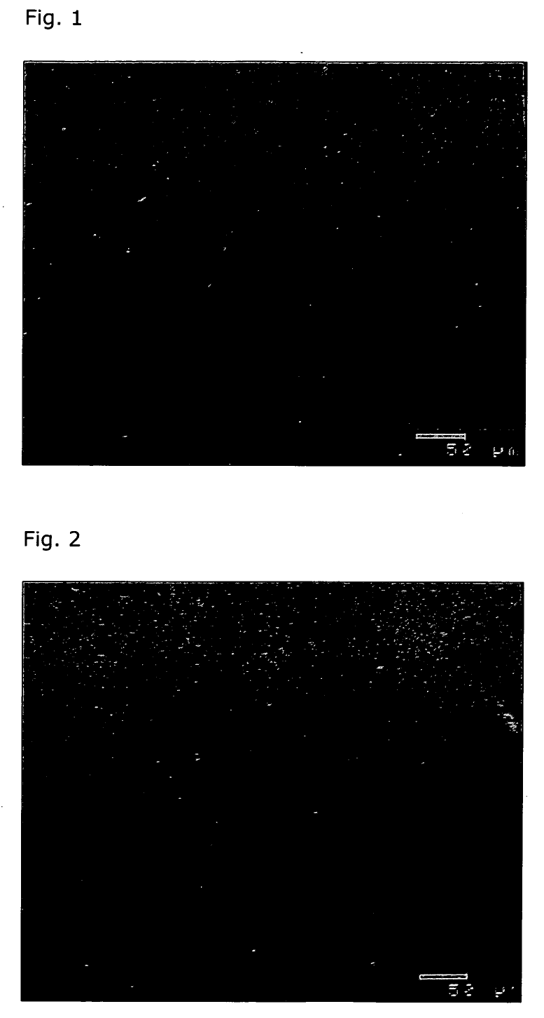

The present invention will be described in greater detail with reference to the figures (FIGS. 1 through 4; the white bar represents a length of 50 μS m in each case), which merely represent selected examples and do not restrict the scope of the present invention in any way.

FIG. 1 shows a blank made of an injection-molded polyamide molding compound, produced according to the present invention, having 6% silicate 1 according to example 1;

FIG. 2 shows a blank made of an injection-molded polyamide molding compound, produced according to the present invention, having 6% silicate 2 according to example 2;

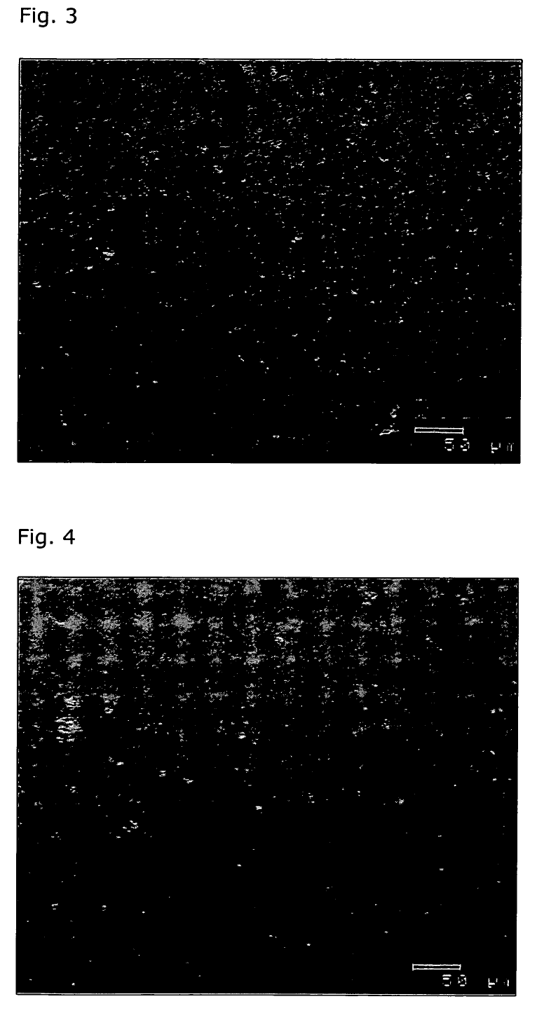

FIG. 3 shows a blank made of a typical, injection-molded polyamide molding compound having 30% normal CaCO₃ for comparison;

FIG. 4 shows a blank made of a typical, injection-molded polyamide molding compound having 40% normal kaolin for comparison.

In examples 1 and 2 below and/or in comparative example 1, polyamide 6 was used in each case, for which the following properties were measured:

the relative viscosity was 2.85 at 1% in sulfuric acid at 25° C.;

the melt-volume index (MVI) at was 90 cm³/10 min. at 275° C./5 kg

The polyamide molding compounds produced according to the present invention (examples 1 and 2) were produced on a 30 mm double-screw extruder ZSK 25 from Werner & Pfleiderer at temperatures between 240° C. and 300° C. In this case, a first part of the polyamides was dosed into the intake and melted and the organically modified layered silicate was admixed with the melt of the polyamides. A second part of the polyamides was then added to the mixture and the resulting melt was finally subjected to filtration. Continuous melt filters from Maschinenfabrik Kreyenborg GmbH (D-48061 Münster-Kinderhaus, Germany) were used for the melt filtration, wire screens located in the pistons, which could be moved hydraulically into the melt stream, being used.

### EXAMPLE 1

Na-montmorillonite having a cation exchange capacity (CEC) of 140 meq/g mineral was used as the layered silicate. The organic modification was performed using 25 weight-percent methyl-bis-2-hydroxyethyl-stearyl ammonium chloride and resulted in a layer spacing of the treated Na-montmorillonite of d_{L}: 1.85 nm. Addition of 6% of this silicate to PA 6 resulted in a blank made of an injection-molded polyamide molding compound which included a smooth surface having a high gloss produced by a molding tool polished to a high gloss (cf. FIG. 1).

### EXAMPLE 2

Na-montmorillonite having a cation exchange capacity (CEC) of 100 meq/g mineral was used as the layered silicate. The organic modification was performed using 30 weight-percent methyl-bis-2-hydroxyethyl-fatty acid ammonium chloride and resulted in a layer spacing of the treated Na-montmorillonite of d_{L}: 1.80 nm. Addition of 6% of this silicate to PA 6 resulted in a blank made of an injection-molded polyamide molding compound which included a smooth surface having a high gloss produced by a molding tool polished to a high gloss (cf. FIG. 2).

### COMPARATIVE EXAMPLE 1

Blanks which were not produced according to the present invention were produced for comparative purposes using addition of 30% natural, milled CaCO₃, having an average particle diameter of 3 μm, a density of 2.7 g/cm³ and a pH value of 9 and a degree of whiteness of 90% according to DIN 53163, to PA 6 (cf. FIG. 3), and/or 40% calcined kaolin, treated with aminosilane, having an average particle diameter of 1.3 μm, a density of 2.6 g/cm³, and a pH value of 9, to a mixture of PA 66 +PA 6I/6T (cf. FIG. 4) and resulted in significantly rougher surfaces—compared to the blanks according to the present invention of FIGS. 1 and 2.

The testing of the molding compounds produced according to the present invention and not according to the present invention (cf. Table 1) was performed according to the following guidelines:
melt-volume index (MVI) at 275° C./5 kg according to ISO 1133 (the abbreviation MVR is also used instead of the abbreviation MVI);
impact strength and notched impact strength according to ISO 179/1eU;
breaking stress and yield stress, breaking elongation, and tensile modulus of elasticity according to ISO 527;
HDT A and B according to ISO 75,

To determine the surface quality of the molding compounds according to the present invention, slabs were produced in injection molds polished to a high gloss and subsequently vapor deposited using palladium. The raster electron microscope pictures shown at 200× magnification (cf. FIGS. 1 through 4) show perfect and uniform surfaces only for the molding compounds according to the present invention.

TABLE 1

| | | | | Example | Example | Comparative |
|---|---|---|---|---|---|---|
| | | | | 1 | 2 | example 1 |
| PA 6 | | | wt.-% | 94 | 94 | 70 |
| Silicate 1 | | | wt.-% | 6 | — | — |
| Silicate 2 | | | wt.-% | — | 6 | — |
| CaCO₃ | | | wt.-% | — | — | 30 |
| Density | ISO rod | | g/cm³ | 1.14 | 1.15 | 1.39 |
| Ash | Granulate/550° C. | | % | 4 | 4 | 31 |
| MVI | 275° C./5 kg | | cm³/10 min | 30 | 25 | 40 |
| Tensile modulus | dry | | MPa | 4400 | 4550 | 4750 |
| of elasticity | | | | | | |
| Breaking tension | dry | | MPa | 100 | 100 | 95 |
| Breaking elongation | dry | | % | 4 | 3 | 4 |
| Impact Charpy new | 23° | C. | kJ/m² | 80 | 80 | 75 |
| Impact Charpy new | −30° | C. | kJ/m² | 70 | 90 | 55 |
| Notched impact | 23° | C. | kJ/m² | 4 | 4 | 4 |
| Charpy new | | | | | | |
| Notched impact | −30° | C. | kJ/m² | 3 | 3 | 4 |
| Charpy new | | | | | | |
| HDT A | 1.8 | MPa | ° C. | 100 | 100 | 100 |
| HDT B | 0.45 | MPa | ° C. | 180 | 185 | 195 |
| Tensile modulus | 150° | C. | MPa | 560 | 580 | 600 |

of elasticity

In addition to the results shown, which were imaged using raster electron microscopy, surface measurements were performed on samples. In this case, the average roughness value (Rₐ) and/or the average roughness depth (R_{z}) were determined according to DIN standard 4768. The resolution of the measurement device was 9.12 nm in each case. The average roughness value (Rₐ) is the average value of the individual roughness depths of five sequential single measurement lengths (Iₑ). The average roughness depth (R_{z}) is the arithmetic mean of all absolute values of the roughness profile R within a total measurement length (Iₘ). The results are shown in Table 2.

TABLE 2

| | Sample | | | |
|---|---|---|---|---|
| | | | | W4320 |
| | W3082_V1 | W3082_V3 | Ultrason E | metallized |
| Average roughness | 0.0734 μm | 0.0734 μm | 0.0329 μm | 0.0334 μm |
| value (Rₐ) | | | | |
| Average roughness | 5.67 μm | 5.67 μm | 1.01 μm | 1.17 μm |
| depth (R_{z}) | | | | |

W4320 is Example 1 according to the present invention, with metallized meaning vapor deposited using aluminum. W3082 V1 and W3082 V3 are PA 6T/6I having the kaolin from comparative example 1. In the examples according to the present invention, organic ammonium chlorides were used to modify the layered silicates. “Ultrason E” is a polyarylene ether sulfone from BASF.

On the basis of grayscale illustrations of the measurements, a limit of still tolerable values of 0.05 μm for Rₐ and of 4 μm for R_{z} were established. It may be clearly seen from Table 2 that the two samples Ultrason E and W4320 fulfill the requirements for good surface quality and therefore also for good imaging of the injection molds when metallized.

Blanks produced according to the present invention, based on aliphatic copolyamides, are suitable for producing reflectors for usage locations which are somewhat less hot, such as reflectors for signal or street lights and/or as sub-reflectors for vehicle driving illuminators. The corresponding molding compounds typically contain approximately 6 to 8 weight-percent phyllosilicate, which provides higher stiffness (tensile modulus), strength, and HDT/A. Using the copolyamide molding compounds produced according to the present invention, economic solutions may be provided as a replacement for more expensive materials.

Admixing the mineral filler to the polyamide in a double screw extruder (compounding) is preferred as the method of producing the polyamide molding compounds. Alternatively, the phyllosilicates may also be mixed into the reaction batch of the monomers of the aliphatic polyamide.

If the compounding method according to the present invention is used to produce the polyamide nanocomposites, two factors must be considered:
1) the distribution of the layered silicate particles is to be as homogeneous as possible;
2) the polyamide nanocomposite molding compound is to experience as little thermal damage as possible.

The distribution of the layered silicate particles influences the surface roughness of freshly produced injection-molded parts. A good distribution may be influenced through the selection of the compounding method. The best distributions were achieved through the addition of the mineral into the melt. If the mineral is added during the melting phase of the polyamide granulate, there is the danger that silicate aggregates could form. Depending on the layered silicate and polyamide matrix, adjustment of the screw geometry and the dosing is necessary in order to achieve strong improvement of the silicate distribution.

Surprisingly, it has been shown that for injection-molded parts made of the polyamide nanocomposites produced according to the present invention, a good surface quality was achieved when a first part (e.g., 60 to 80 weight-percent, preferably 70 weight-percent) of the granulate of the polyamides was dosed into the intake of the extruder and the organically modified layered silicate (preferably 2 to 8 weight-percent, especially preferably 2 to 6 weight-percent, very especially preferably 2.5 to 6 weight-percent) was dosed into the melt of this granulate component. This was preferably performed without using a side feeder, simply through gravity, so that then approximately 40-20%, (preferably 30 weight-percent) of the layered silicates are in the mixed melt referred to in the following as the “masterbatch”.

However, the best surface quality is achieved when, for a method for producing polyamide nanocomposites from polyamides and organically modified layered silicates in a double screw extruder, a first part of the polyamides is dosed into the extruder intake and melted and the organically modified layered silicate is admixed with the melt of the polyamides, then a second part of the polyamides is added to the masterbatch and finally the resulting melt is subjected to filtration. This melt filtration is preferably performed directly before the extruder nozzle. Alternatively, a melt filtration may be performed during a separate extrusion procedure.

Various systems may be used for melt filtration, for example, sand filters or continuous melt filters from the companies Gneuss or Kreyenborg. In the latter method, wire meshes are used, which are located in the piston and may be moved hydraulically into the melt stream. Preferably, at least two filters are used simultaneously, so that operation may be continuous. In normal operation, wire filters are located in the melt stream. To replace the filter, a piston, including the filter, is pulled out of the melt and a screen replacement is performed. The second filter is then subsequently replaced analogously. The mesh width of this wire filter is preferably at most 200 μm, especially preferably between 50 and 100 μm.

A second part of the polyamides is first added later in order—in only one single further step—to set the final concentration of the layered silicate at at most 10% in the melt of the polyamide nanocomposites. Through this two-step technique, optimal exfoliation of the layered silicate is achieved, without agglomerates forming in the polyamide nanocomposite molding compounds. This addition of the second part of the polyamides is preferably performed via a side feeder; alternatively, the second part of the polyamides may also be added to the melt mixture in the extruder through dripping in.

All statements in weight-percent relate to the sum of the recipe components of 100 weight-percent.

The extrusion parameters (low temperature profile, high speed, high throughput) and the screw geometry are preferably selected in such a way that a high shear is achieved. The speed of the screw is preferably more than 200 rpm in this case. A speed of at least 300 rpm is especially preferable, and a speed of 400 rpm is very especially preferable.

A high throughput is also preferred. For the double screw extruder used (WP ZSK 25) a throughput of 20 kg/hour represents the maximum in combination with these recipes. In general, however, operation should always be in the upper quarter of the throughput and speed range of the extruder used, preferably at the upper throughput and speed limit. The throughput limit is determined by the maximum possible torque at the desired low temperatures.

The screw geometry is also significant. Good melting of the first granular component is to be ensured, e.g., through kneading blocks, before the layered silicate is added. After its addition and before the side feeder, a good mixing effect is also necessary. After the side feeder, sufficient kneading and mixing action must be provided. Measures which increase the dwell time also have a positive effect on the result, but may not lead to excess degradation of the polyamides.

In addition, the screw is preferably to be designed in such a way that the application of vacuum before the nozzle is possible for degassing. In this case, a pressure and/or a vacuum of less than 200 mbar is preferable; a pressure and/or a vacuum of less than 50 mbar is especially preferable.

The temperatures set on the extruder are to be selected as rather low, in relation to the melting point and the melt viscosity of the polymers. Temperatures which are 10C to 20° C. lower than when incorporating other fillers are preferable.

Too much thermal stress of the polyamide nanocomposites produced according to the present invention leads to problems in later operation of the reflector components due to exudation of the degradation products of the polyamide and the substances used for the silicate modification.

The use of organic ammonium salts (cf. Examples 1 and 2) has proved itself for the organic silicate modification. More recent experiments have shown, however, that layered silicates which were organically modified using phosphonium salts of the formula P—R₄—X produce an especially good, if not even better surface quality of the injection-molded parts in combination with the production method according to the present invention. In this case, R represents alkyl or aryl residues and X represents a Cl, Br, or I. An explanation for the especially good result may be that phosphonium salts cause an especially high thermal resistance of the polyamide nanocomposites.

Instead of one single type of polyamide, the use of a polyamide blend is also possible.

The polyamide molding compounds according to the present invention are preferably used for the injection molding of reflectors (and/or sub-reflectors). To obtain especially precise reflector surfaces, the gas injection molding technique (see PLASTVERARBEITER [Plastics Processor], May 2002, published by Hüthig Verlag, D-69121 Heidelberg, for example) may be used during injection molding in a special version.

1. A method of producing a polyamide nanocomposite
from partially crystalline polyamides and organically modified layered silicates in a double screw extruder,
a first part of the polyamides being dosed into the extruder intake and melted and
the organically modified layered silicate being admixed with the melt of the polyamides and
then a second part of the polyamides being added to the mixture,
characterized in that the resulting melt is subjected to filtration.

2. The method according to claim 1, characterized in that the filtration of the melt is performed directly before the extruder nozzle.

3. The method according to claim 1,
characterized in that a melt filtration is performed during a separate extrusion procedure.

4. The method according to claim 1,
characterized in that wire filters having a mesh width of at most 200 μm, preferably between 50 μm and 100 μm, are used to perform the melt filtration.

5. The method according to claim 1,
characterized in that, with the addition of the organically modified layered silicate, a mixture ratio in the range of 60 to 80 weight-percent of polyamides and 40-20 weight-percent of layered silicates is produced and the second part of the polyamides is added to the mixture in the quantity necessary in order to achieve the final concentration of the layered silicates of at most 10 weight-percent in the melt of the polyamide nanocomposite.

6. The method according to claim 5, characterized in that, with the addition of the organically modified layered silicate, a mixture ratio of 70 weight-percent of polyamides and 30 weight-percent of layered silicates is produced and the second part of the polyamides is added to the mixture in the quantity necessary in order to achieve the final concentration of 2.5 to 6 weight-percent of the layered silicates in the melt of the polyamide nanocomposite.

7. The method according to claim 1,
characterized in that the layered silicates are organically modified using phosphonium salts of the formula P—R₄—X, R₄ representing three alkyl or aryl residues and X being a Cl, Br, or I.

8. The method according to claim 1,
characterized in that the exfoliated layered silicates have an ultrafine grain having an average particle size in at least one dimension of at most 100 nm.

9. The method according to claim 1, characterized in that the polyamides are selected from the group consisting of homopolyamides PA 6, PA 66, PA 46, as well as PA 11 and PA 12.

10. The method according to claim 1,
characterized in that the partially crystalline polyamides are admixed with a component of amorphous polyamide.

11. The method according to claim 1,
characterized in that the organically modified layered silicates include phyllosilicates of the three-layer type (2:1).

12. An injection-molded part, which is produced using a polyamide nanocomposite obtained according to the method according to claim 1,
characterized in that it has a surface which has an average roughness value (Rₐ) of less than 0.05 μm and/or has an average roughness depth (R_{z}) of less than 4 μm.

13. The injection-molded part according to claim 12,
characterized in that it includes a smooth surface having a high gloss produced by a molding tool polished to a high gloss.

14. A reflector for vehicle driving illuminators,
characterized in that it includes an injection molded part according to claim and is metallized directly.

15. A reflector for signal or street lights and/or a sub-reflector for vehicle driving illuminators,
characterized in that it includes an injection molded part according to claim 12 and is metallized directly.

16. The reflector according to claim 14,
characterized in that the metal coating is applied through PVD methods.

17. A method of using a polyamide nanocomposite molding compound produced according to claim 1, comprising injection molding said molding compound reflector into a for vehicle driving illuminators.

18. A method of using a polyamide nanocomposite molding compound produced according to claim 1, comprising injection molding said molding compound into a reflector for signal or street lights or into a sub-reflector for vehicle driving illuminators.

19. The method of claim 17,
characterized in that a gas injection molding technique is used during injection molding.

20. The reflector according to claim 15, characterized in that the metal coating is applied through PVD methods.
